(19) United States
(12) Patent Application Publication
(10) Pub. No.: US 2014/0278828 A1
(43) Pub. Date: Sep. 18, 2014

(54) METHOD AND SYSTEM FOR DERIVING PRODUCTIVITY METRICS FROM VEHICLE USE

(71) Applicant: Dean Dorcas, Kent, WA (US)

(72) Inventor: Dean Dorcas, Kent, WA (US)

(21) Appl. No.: 13/827,520

(22) Filed: Mar. 14, 2013

(51) Int. Cl. G06Q 30/02; G06Q 10/06

(52) U.S. Cl. CPC G06Q 30/0207; G06Q 10/06398
USPC 705/7.42

(57) ABSTRACT

A system and method distributes incentive payments to employees performing warehouse tasks to reward productivity. Time-stamped data from sensors on a vehicle having a vehicle code is periodically retrieved to provide trip onset and trip conclusion events and an employee code associated an operator. The data includes a vehicle code trip distance; and any lift events. Job onset and job conclusion events and the employee code associated with each job code as well as time clock events including clock in and clock out data are used to provide segments in a timeline, the segments bounded by trip onset events. Lift time within a segment is derived by adding a fork lowering time equal to any fork raising time to a laden time present within the segment. Aggregating time and movement within a segment to produce a utilization percentage of the segment. A tracked time ratio includes segments within an interval.

### FIELD OF THE INVENTION

A method and system for recognizing productivity and providing incentive for productivity among warehousemen.

### BACKGROUND OF THE INVENTION

Even though warehouses in distinct industries can serve quite different ends, most share the same general pattern of material flow. Essentially, any warehouse receives bulk shipments of goods, stages those goods within the warehouse for quick retrieval; then, in response to customer requests, retrieves and sorts goods, and then ships them out to customers. These steps are universal within most warehouses as they serve as a sort down from bulk shipments to fulfillment of specific orders.

A general rule for optimizing costs within a warehouse is that product should stop, as little as possible, in its otherwise continuous flow through this sequence. Each time a good is put down means that it must be picked up again sometime later. Anytime that an additional movement of the goods or “double-handling” occurs, the price of warehousing the goods becomes more expensive without providing a commensurate benefit to the customer nor to the warehouseman.

In studying the problem of the movement of goods through the warehouse, conventional wisdom as to warehouse management has defined a good's optimum path as having defined segments and each segment is a distinct task or series of tasks within the warehouse:
1) Receiving and Inspection-receiving inbound material, validating the material against a purchase order, and checking for damage.
2) Material Handling and Putaway-managing the movement of products to an assigned storage, replenishment or pick area as slotted.
3) Storage and Inventory Control-process of holding material and processes of counting and transacting the material as it moves through the warehouse.
4) Picking and Packing-locating and pulling product from inventory and packing it into shipping containers to fill a customer order.
5) Load Consolidation and Shipping-processes that support the transport of products and the infrastructure that supports delivery.
7) Shipping Documentation-generating all required documents and labels for a shipment in compliance with the customer, carrier, and government regulations.

Each task includes movement of goods and often movement is accomplished by using vehicles traveling on trips along paths within the warehouse. Because of the vast number of trips, i.e. the product of the listed tasks multiplied by the number of goods on which those tasks are performed, optimizing the trips is a method of minimizing costs within the warehouse. One approach to optimization is selecting idealized paths for trips through the warehouse. Unfortunately, the number of variables necessarily involved in constructing idealized paths is dizzying and the adding of just a few distinct goods, each having distinct locations, increases the complexity of the problem geometrically.

As inventory grows, the path drawing complexity rapidly outstrips ability of a human manager to suitably stage the warehouse. Due to the complexity of the problems and the need to track goods through the warehouse, many warehouse managers rely upon a software solution running on a computer server, together generically known as a warehouse management system or WMS.

The WMS is capable of instantaneously locating goods within a warehouse and, thus, to process the transactions common to most warehousing operations: receiving, put away, picking, checking, packing, and shipping. Within the WMS, goods are not actually tracked in movement but rather the good is serially logged as residing at one first static spot and later logged as residing at another, for example, an identified good rests at a loading dock and later on a shelf for storage. A good is visible to the WMS between each movement of that good but not during movement. As such, a WMS system cannot help to optimized paths of goods within a warehouse except to align the static spots that a good might occupy in the warehouse. WMS is not about movement but about shelves.

But a WMS can contain very valuable data that can inform decisions as to movement. As WMS have moved from the use log books requiring personal logging of each good at a location to more accurate and instantaneous systems which rely upon electronic means help to locate each good within the warehouse, pick up and drop off data have become tied to specific times within the warehouse. As such, trips of goods through the warehouse are recorded by recording onset and completion times as well as starting points and endpoints, thus, the approximate paths goods take through the warehouse are knowable from examination of WMS records.

Together described as Auto ID Data Capture (AIDC) technology, most WMS use methods of automatically identifying goods, collecting data about them, and entering that data directly into computer systems (i.e. without human involvement) to yield valuable data when the time and location of the data capture are likewise known. AIDC includes technologies such as barcode scanners, mobile computers, wireless sensors on LANs, radio frequency identification (RFID) and other proximity technologies that, without error or tedious labor that manual entry imparts, can yield timeline data for arrivals and departures of goods along with locations. WMS can, thereby, have nearly instantaneous records of not only at what spot a good dwells but also when it arrived there or departed from the previous spot. As such, goods move through virtual pipelines disappearing from one location to materializing at another at given times.

Optimizing the pipelines has been touted as the remaining frontier in warehouse management. In terms of labor, movement of goods is the single most expensive cost in running a warehouse. For example, the process of put-away of goods on shelves typically accounts for about 15% of warehouse operating expenses. Additionally, order picking has long been known as the most costly and time consuming activity within a warehouse setting. In order picking, an operator removes and collects a small number of goods from locations within a warehousing system, to satisfy customer orders. Order-picking typically accounts for about 55% of warehouse operating costs and of that, traveling makes up about 55%. Notice that traveling comprises the greatest part of the expense of order-picking, which is itself the most expensive part of warehouse operating expenses.

To minimize movement along the above described virtual pipelines, earlier conventional solutions exploit motion study methods to make traveling more efficient. The object of such studies is to translate the virtual pipelines existing within the WMS into actual physical paths through the warehouse. Pursuit of optimal paths has resulted in some very elaborate software programs exist which function by the construction of maps for tracking the movement of the goods in 3-dimensioned space as a function of time. On such approach is that of Andersen, et al, as taught in U.S. Patent Publication 2012/0191272 dated Jul. 26, 2012 and monitors the location and orientation of each vehicle in the warehouse by using a position and orientation sensor and a fixed base infrastructure. The infrastructure also communicates with the vehicles to determine the makeup of a load, when the load is deposited on an automatic conveyor device and each instance of subsequent movement by load conveying vehicles.

The premise of conventional software is that given a complete and accurate representation of the warehouse in x, y-, z-axis mapping of the spaces between defined nodes, a computer can calculate the shortest path and where several goods are moving, coordinate those paths to direct movement along paths which taken together are the shortest possible movement of goods through the warehouse. All locations within a warehouse must be known and then elaborate equipment used for tracking movement through the known x-, y-, z-axes model. Without discussing the practical challenge that performing such an analysis, the system is only worthwhile if savings in movement prices can be greater than capital costs. The capital costs in setting up such a system are monumental and very often hard to recoup in efficiency gain. When setup is accomplished, such a system can be very precise but may well be too complex to change as the makeup of goods within the warehouse changes.

What is needed in the art is a method and system for deriving performance criteria for people and machinery in operation of a warehouse facility while avoiding the tremendous expense of three dimensioned mapping of warehouses to create optimized paths.

### SUMMARY OF THE INVENTION

Rather than attempting to map each route for each unique good through the warehouse, the instant invention relies upon suitably incentivized workers to find the most efficient paths for moving goods through the warehouse. Incentives are based upon comparison of times as employees complete known tasks to a labor standard established for that task. A Utilization Rate is derived by studying vehicle movement through the warehouse. (The time that a vehicle the operator is using to move goods, while it is moving is added to twice its lift time and then divided by the total time spent to yield a Utilization Rate, i.e., movement time+2*Lift Time)/Total Time). The comparison occurs as the Utilization Score is derived. (A Utilization Standard (each is known and recorded for any specific process) is then divided by the Utilization Rate accomplished by the employee.) Utilization Rate does not include travel distance or any other metrics, but rather such metrics are incorporated in the Utilization Standard for the performed task. The Performance Score then combines the utilization score and the productivity score at the process level. So for a given task, an employee might have a productivity score of 100% and a utilization score of 80%. If they are weighted evenly for that process then the Performance Score for that process would be 90%. For each of the other processes an employee performs daily, the employee garners a Performance Score and then the method and system combines all the scores for the day and the system and method calculates employee bonuses based on their prorated hours on each process.

The computer-assisted method distributes incentive payments to employees performing warehouse tasks to reward productivity. Time-stamped data from sensors on a vehicle having a vehicle code is periodically retrieved to provide trip onset and trip conclusion events and an employee code associated an operator. The data also includes a vehicle code and any lift events. Job onset and job conclusion events and the employee code associated with each job code as well as time clock events including clock in and clock out data are used to provide segments in a timeline, the segments bounded by trip onset events. Lift time within a segment is derived by adding a fork lowering time equal to any fork raising time to a laden time present within the segment. Aggregating time and movement within a segment to produces a utilization percentage of the segment. A tracked time ratio includes segments within an interval.

### BRIEF DESCRIPTION OF THE DRAWINGS

Preferred and alternative examples of the present invention are described in detail below with reference to the following drawings:

FIG. 1 depicts a data flow diagram for generating a near real time productivity and cost report for providing performance incentives to employees of a warehouse;

FIG. 2 is the first sheet of a two sheet flow chart for an embodiment of a system and method for providing performance incentives to employees of a warehouse;

FIG. 3 is the second sheet of a two sheet flow chart for an embodiment of a system and method for providing performance incentives to employees of a warehouse;

FIG. 4 is an exemplary Supervisor Productivity Report generated by the system and method; and

FIG. 5 is an exemplary Budget Process Analysis generated by the system and method.

### DETAILED DESCRIPTION OF THE PREFERRED EMBODIMENT

Warehouse management systems (WMS) lend insight into the actual location of goods within a warehouse but are not generally useful as tools for making efficient movement through the warehouse. Because locations of goods are static in most WMS, using WMS to increase efficiency in warehouse operation can only be achieved by using other systems to place the most needed goods on the shortest paths through the warehouse. To achieve any efficiency, then, an operator of a vehicle strives to select paths that place trip onset times and trip conclusion times such that they are separated by the shortest possible intervals when lift vehicles are operated at regular speeds. Thus, to minimize these intervals, conventional practices for warehouse management include creating a catalogue or mapping of shortest paths for most frequently ordered goods within a warehouse. To develop the catalogue or mapping, the conventional solution requires an elaborate calculation of shortest paths for the most frequently ordered goods to thereby minimize any good's travel times through the warehouse.

Such a plan for creating shortest paths is extremely costly but even if created may not be able to really achieve the goal of directing goods along the optimal paths through the warehouse. In reflecting upon the enormity of the optimum path solution, one is reminded of Tom Cargill's famous aphorism at Bell Labs: “The first 90 percent of the code accounts for the first 90 percent of the development time. The remaining 10 percent of the code accounts for the other 90 percent of the development time.” As can so often be the case with software-based solution, the 100 percent solution is elusive and expensive.

In pursuit of the conventional solution of the problem of warehouse efficiency, elaborate maps in three-dimensioned space are developed for optimum transit of goods through the warehouse. Efficiency of operations and, thus, the operators who perform them has been judged by the metric of conformity to these optimum paths. Such a solution is inherently unwieldy as it is complex. Conformity to optimal curves does not speak to such important metrics as operator productivity or efficiency. Naturally, the latter two metrics are far more important when determining whether a warehouse is operating at to produce maximum benefit for the owner. Thus, the conventional solution of mapping paths simply does not yield desired savings, especially when normalized for the extreme capital costs such mapping entails.

Unlike the conventional solutions offered within the prior art which rely upon an exact map of the goods space and optimal paths within a warehouse, the instant system and method rely upon what has been called the eighty twenty rule. The method of the instant invention heeds the advice Gary Di Camillo, the former CEO of Polaroid, laid out, “If you wait until you have a 99 percent solution, you'll never act. Go with an 80 percent solution.”

Throughout this application, three terms will be used to denote efficiency in performing tasks. The first of these is productivity, which when used herein means actual time as a percentage of a selected labor standard—how long the task should have taken as compared to how long it took. The second term is utilization score relating to a vehicle such as a fork lift the percent of time that the fork lift is using its lift capacity or driving as compared to a standard for the vehicle for a given task. The last term is the performance score which is a weighted composite of the two earlier scores and is specific for each defined task.

To study movement of goods, the instant solution relies upon data received from the vehicles that enable goods to move. On most every lift truck currently available there is, at least, an hour meter that records the hours that the lift truck operates. On many lift trucks, there are multiple hour meters. Hour meters available in conventional lift trucks and fork lifts can include:

Travel hours=Hours measuring the use of the drive motor;

Lift hours=Hours measuring the use of the lift motor;

Deadman hours=Hours used to measure the total use of the lift truck—measuring the amount of work on each motor a combination of both lift hours and travel hours called, collectively, deadman hours; and

Key hours=Hours measuring the time the key is turned to “on”.

The method gainfully exploits these metrics for insight into the use of the lift trucks, forklifts or other monitored vehicles and, by extension, the operator's efficiency in using the vehicle. For example, by knowing the travel hours and the lifting hours, a manager of a warehouse is able to make a determination as to whether the assigned operator is idle or working at a level of productivity. All travel and no lifting on a forklift might suggest an operator who prefers to drive laps rather than moving pallets. Just as an efficient waiter quickly learns each trip to or from a table ought to include moving menus, plates, or food, a lift truck should have a pallet on its forks as often as possible in the course of movement through the warehouse.

Examining deadman hours, a manager can glean further insight into productivity. By estimating the number of pallets that are shipped and received, the manager can divide the number of pallets handled by the total number of lift truck deadman hours used in a unit day, week or month. Using this measurement, the manager can come to an extrapolated number of pallets moves per hour. Nonetheless, simple movement of pallets is not a metric that speaks to productivity, but, yields an incomplete insight into operator efficiency.

Manufacturers of vehicles and lifts for warehousing operations have developed on-vehicle monitoring systems for fleet management to record information present when a triggering event is detected; the event is logged, and then placed into the data structure of a fleet management software console by communicating the information to an application server. To track use and predict maintenance on the vehicle, such a system tracks the vehicle speed, load, or several other measurable parameters and compiles these parameters into an event report. Notably, the system can transmit the report to the application server 14 by wireless means allowing nearly instantaneous monitoring of the fleet of vehicles. For example, if an impact is detected at one of the accelerometers onboard the vehicle, an event process creates an event report by saving logged data from a time window that may extend a predetermined time before the impact to a predetermined time after the impact. Also, upon detecting an impact, certain vehicle components may be selected and polled to ascertain operating status information. Certain additional data may be recorded regardless of the type of impact, such as by logging a time-stamp, operator identification, etc.

Advantageously, in order to use a vehicle asset having the vehicle monitoring system, a user must log onto the vehicle, e.g., a forklift truck. In the inventive method and system, the user is then associated with the movements of the vehicle and using that association, the user's time of movement through the warehouse can be discerned. In conventional vehicle monitoring systems, when an operator must provide a password, the interface controller verifies whether the presented logon information identifies an operator that is authorized to operate the forklift truck and further time-stamps and records the logon. At an appropriate time when a transceiver in data communication with the mobile asset application server sends the collected information to a suitable storage location, such as a data resource that may be maintained by the mobile asset application server.

Referring to FIG. 1, by way of overview, the instant method and system 10, tempered by a universal system time 19, relies upon a number of metric sources, specifically, where available, the server 21 makes suitable queries to find four data structures available in the trip file and makes these inquiries, at least in the preferred embodiment, on a daily basis:

Time-clock file 13 including the specific hours each individual employee worked that day;

Job Code File 15 from a server, the file including the start and end time for each process upon which equipment each operator worked on that day (e.g. “Picking” Start time 8:15, End time 8:35);

Trip Files 15 with a Laden/Unladen Flag, where available the files indicating the type of equipment used (e.g. Reach Truck or Pallet Jack), as well as the specific time the vehicle was moving and the specific time it was lifting the forks; and

Auto ID Data Capture (AIDC) 17, where available from a Warehouse Management System (WMS) or other source of production data recording system such as a voice pick system.

By way of overview, the Server 21 merges the last three files and exploits and unified time stamp to generate a single timeline so that these diverse data can be compiled together to form a single data structure. Importantly, when so compiled, the timeline gives definition to the work without requiring a specific mapping of each path. Unlike conventional strategies seeking to shave time off of trips within the warehouse, the instant solution places a greater value on knowing what an employee is doing rather than knowing the x-, y-. and z-space coordinates of the employee's movement through the warehouse when he or she is doing it. Once the timeline data structure is done, the server can generate at least a report that gives an overview such as the Dashboard Report 31 showing productivity of either a single employee or some group of employees when compared to a designated labor standard for each task such as Picking, Putaway, and Receiving and where that group of employees is the whole of the warehouse staff, the facility itself can be rated relative to the designated Labor Standard.

As configured, the system and method 10 can, optionally, create a data structure that will yield a Cost Breakdown Analysis 33 displaying that distinct data structure either by employee or by groups of employees. As shown in this exemplary Cost Breakdown Analysis 33, costs attendant to each task, in this case Assembly, give the manager a real sense of the cost of each function within the warehouse. Naturally, with cost as a metric, strategies for awarding incentives for efficiency can be readily incorporated into the management of the warehouse.

Similarly, a Daily Production Report shows the productivity of various employees when tracked against the Labor Standard the manager designates upon the server. On the whole, Rodney Armstrong achieved 95.3% of the designated Labor Standard, and as a result, during his 7.6 hours earned no additional bonus to add to the $23.11 in bonus money he had earned earlier in the pay period. These bonuses incentivize workers to beat the standard. In essence, a virtual warehouseman races each worker, that virtual warehouseman characterized by the designatable labor standard; when the worker wins, he or she receives a bonus and, to make the bonus incentive clear and specific, that bonus is credited to the worker-viewable bonus account on the same day. In short, the worker wins real money, in nearly-real time for objectively awarded incentives.

Referring now to FIG. 2, a reliable network time source such as a system clock broadcasting a system time 19 throughout the system 10, lending utility and apples-to-apples tracking of events. The use of a system clock is not, itself, novel. In, for example, a Windows™ based system, system time is kept as the current date and time of day. The system keeps time so that applications have ready access to accurate time. The system 10 bases system time on coordinated universal time (UTC). UTC-based time is loosely defined as the current date and time of day in Greenwich, England. For each component within the warehouses network, generally synchronized at boot-up, time is uniformly reflected across the system. When any component in the system first starts, it sets the system time 19 to a value based on the real-time clock of the server and then regularly updates the time. To retrieve the system time 19, a Windows™ based system will use the GetSystemTime function. GetSystemTime copies the time to a SYSTEMTIME structure that contains individual members for month, day, year, weekday, hour, minute, second, and milliseconds. The GetSystemTime function synchronizes each component with a single time source using a periodic time adjustment applied at each clock interrupt. Thus, each component within the system is presumed to reflect the exact same time within very tightly configured standards, certainly with enough precision to enable the system 10.

Based upon the system time 19, the on-board sensors on the various warehouse vehicles, collectively referred to herein as a sensor complement 41, construct a data structure which, for purposes of this exemplary explanation will be chosen to be a subset of those data the system compiles. Importantly, each event the sensors sense is recorded in association with the system time at which it occurs; the events are said to be “time-stamped” with system time 19. Because the system time 19 is uniform across the system, an event recorded by one sensor in the sensor complement 41 can readily be coordinated against other events recorded by the sensor complement 41 on other vehicles, on a time clock 45 or on a Job Log In pad 47.

Additionally, while the system does not require input from an Auto ID Capture Device 43, within a WMS, where it exists, the presence of that data reflecting movement of goods in a Good Movement Log 49 (This explanation is not limited to entries by an Auto ID Capture Device 43; rather for convenience and clarity, only the Auto ID Capture devices are shown as entry means, but all means are included explicitly here.) further refines the result and, for the exemplary purposes of this explanatory discussion, though optional, will be included in this discussion.

As set out in the Background, WMS view goods as static, located first at one place and then located later at a second place. Passing, as they do, from the one place to the second place, the goods first disappear from the system when they are removed from the first place. At a later time, they appear in the second place. In some advanced WMS, the goods are identified as entering a virtual pipeline as they leave the first place and leaving the virtual pipeline when they appear at the second place. The logging, whether aided by an Auto ID Capture Device or by operator logging by wand or voice, occurs at specific standard times and often associated with the operator who moves the goods through the virtual pipeline. These movements of goods along with the associated standard times are recorded in the WMS in the form of a log data structure. In this explanation, an operator logs the movement of goods from one static place to the second place and, thus, compiled in a Goods Movement Log 49 shown in standard time. These data are a valuable but not a necessary enhancement to the system and method herein.

In this explanation of the system and method 10 presumes the existence three and optionally four files. There exists a time clock file 51. By virtue of the time clock file 51, there exists a record of each subject worker as they log onto the job and as they log off. The electronic analog to the time card as punched by a time clock, time clock file 51, electronic timekeeping systems allow hourly employees to record their hours worked in real time by clocking in and out at a timekeeping terminal or an on-screen time clock (as permitted by an appropriate administrator).

Very like the time clock file 51 is the job file 53. Job costing is an important function for every business that has employees, sells good, or provides services to customers. Job costing is especially important for warehouses, because the manager has a need to know what tasks their employees are performing. As stated above, there are defined tasks in facilitating the trajectory of a goods travel through the warehouse: Receiving and Inspection; Material Handling and Putaway; Storage and Inventory Control; Picking and Packing; Load Consolidation and Shipping; and Shipping Documentation. Each of these is a distinct job. Conventionally, these jobs are arrayed on an axis of a matrix that further relates them to a vendor, supplier, brand or industry in order to yield task codes to define what an employee ought to do or has done to complete a day's work. In the instant method, in order to be eligible for consideration for receiving bonuses for expeditious or efficient task performance, employees have a great incentive to log into individual jobs, to report their commencement and completion thereof. The job file 53 defines segments of an employee's work day that make up the “atoms” of performance. The job file 53 log in and log out times are a first insight lent to a manager, even in a simpler system than the instant one, as to how an employee expends the work day.

The method examines the data the job file 53 contains and exploits the start and end time found the job file 53 to calculate the total time for the logged task. By way of example, discerning in an employee's job file that the employee was occupied from 8:00 am-10:30 for the task of picking and did so using a particular reach truck. Knowing the moments on the standard clock for the commencement and completion, the system can then divide data from other files in accord with the defined tasks.

As mentioned above, optionally, when available, the method and system 10 can augment the data found in the job file 53 to advantageously use those data that are available as stored in the WMS log 49 to show the movement of goods associated with the task as it is being performed. As described above, the virtual pipelines for goods are important in determining the efficiency of a particular movement of goods within a warehouse. Logging the goods in from a first known location to logging them out of a second know location yields intervals when the goods are in transit as well as their departure and arrival locations. By knowing the departure and arrival times and locations as well as the identity of the operator, just as the trip files 55 to define the pipeline, the WMS log 49 defines the contents of the pipelines during those defined intervals.

At the center of the method and system 10 are the data contained in the trip files 55. As described above, the trip files, in one nonlimiting embodiment, include, with reference to any one asset: truck serial number, operator identification, model; key hours, deadman hours, travel miles, travel hours, lift hours, and speed and acceleration parameters. Because these trip files 55 are time stamped using the standard clock 19, the employee's assertion as to how the employee is using time as those assertions are recorded in the job file 53, the trip files 55 and job files 53 together show the movement of the vehicle asset being correlated to tasks.

Each trip file 55 yields a great deal of information. Realizing that it is part the purpose of the instant invention to track movement of good without having to map travel in three-dimensioned space, the files are much more important because they show distance and time associated with an operator moving goods. Advantageously, these metrics need not be derived from movement along mapped three-dimensioned paths but, instead, are available for direct use by the system and method 10 in the trip file 55 for determining the cost of movement of the goods and the productivity of the operator. To be of use, however, the data contained in the trip file 55, must be conditioned.

At a block 57 in the method the system retrieves, from the file, the number of minutes that the vehicle was moving during a defined segment and the number of minutes within the segment the vehicle was lifting. In exemplary embodiments of the method and system, the lift time is doubled to account for dropping the fork as well as lifting it. (Lift time on most vehicles is to show when the lift motor was used for maintenance purposes not for time the fork is aloft.) In conditioning the data, the system and method 10 divides the movement time by the segment time to come up with a “movement %” for each segment.

At a block 59, the system and method 10 then aggregates the lift time within the segment and, as discussed, doubles that lift time (to add in the time it takes to lower the forks as well) to develop the time within the segment when the forks were in motion. At a block 61, the system and method then compares the time the forks are in motion with the segment with the total segment time to come up with a “Lift %”. The system and method 10, then, both a Movement % and a Lift %, at a block 63 plus the 2× Lift time to come up with a total that gets divided into the segment time to determine a Utilization %.

At a block 65, the jobs file 53 is merged with the trip file 55 data as now conditioned to create a timeline file. Specifically, by way of using the prior example as an explanatory model, any lines from the trip file 55 that fall within the job code time range are assigned to that picking segment. At that point, the segments that fall within the bookends the jobs file 53 defines are used to calculate the total distance traveled with load and without load for that segment based on this information. In this manner, all of the trip segments within the bookends data from the jobs file 55 defines, do, in the presently preferred embodiment, preserve their separate data while at the same time, the aggregate data for the segment is also known.

As stated above, the resulting timeline and the optional WMS log data are merged in accord with the time stamping from the standard clock 19 at a block 69 where that optional data is available. Where a WMS datum appears to be inconsistent with or outside of bookends by data from the job file 55, new jobs are created at a block 71. Where the system and method 10 can do so by examination, the new jobs are assigned to an appropriate job code.

Referring to FIG. 3, the WMS data that cannot be matched to either an entered task from the job code file or to job code assigned by the system and method 10, the WMS data is flagged as missing a metric and are saved to show nonconforming data at a block 73. These metrics are compiled and show up on the report but they are not assigned to the Job Code Process. Therefore the performing employee does not get credit for the work that lacks the metric. Removing work from counting in the employee's endeavor in earning bonus credit is based on the fact that the employee had the opportunity to log onto the job and therefore receive credit for that work. The benefits of this method are twofold: An employee cannot game the system by selecting the wrong job code in order to get a higher score relative to that work. The practice also causes employees to develop optimal habits in logging the proper job code when switching processes providing the system and method 10 with accurate information.

A further option that allows comprehensive tracking of work is that of allowing the manual entry of tracked work where work data are available without the benefit of those data generated by the systems on board and monitoring lift vehicles. For example, where picking occurs by individuals without vehicles, WMS data and manually entered data can be compiled to suitably place actions on existing or distinct timelines to give a fuller picture and to release the system and method from dependence upon vehicle monitoring in order to generate the suitable timelines at a block 75. To the extent that some work is performed but not tracked by any means electronically, it, too, can be manually entered into the system or uploaded via spreadsheets.

When all available data have been suitably incorporated into a comprehensive timeline, at a block 77, the system and method 10, for each employee, the data for each segment are compiled according to process such that all segments of a given process are summed together (e.g. picking processes) during the day become one line in a compiled report file relating to an employee's work at, for example, picking

Once time spent on each process, e.g. picking, and all of the associated metrics are aggregated, the meaningful metrics as to employee efficiency can be derived from the summed performance score garnered while performing the process. Continuing the example, for picking the total number of units picked, the number of loaded trips performed, the feet traveled with a load (broken down into acceleration, at speed and deceleration using physics equations to determine a number of feet it takes to accelerate or decelerate). Optionally, the system and method 10 also has the ability from the accumulated metrics to derive other valuable metrics such as the number of locations, the number of orders filled, the number of destination and product scans performed, the number of eaches (meaning each item, each case, each pallet, or any other good that is measured per item), the number of each picks, number of pallets. The fact that metrics can be derived means that each employee's performance in each segment can be compared to specific metrics for labor standard configured for each process. Some employees may have 4 or more different processes they performed during the day

Once the system and method 10 have compiled all of the processes upon which the employee worked in a given day, evaluated the time spent on each process, and extracted the metrics from the tasks performed, these yield numbers that can be compared to the idealized worker as embodied in labor standards. Understanding that each metric has a minutes/unit value assigned to it in the system for a given process, there little problem defining a data set to be used as the definition of the labor standard. Populating the model with designatable data is done by any of several ways. The easiest and likely the most common will be by designation in accord with a manager's expectations, though generally to be effective for motivation, the designations will be informed by empirical experience. So designating these data is also a starting point for a second means, populating the data by iterative optimization.

Iterative methods use information from previous iterations to gradually learn the optimal data, in terms of efficiently providing incentives to workers, compensating for system uncertainty and variation. In rough cut, consider that data set too low in predicting optimal performance may well award every employee bonus credits in spite of how efficiently they perform the subject process. In two ways, too low a standard hurts performance by, first, costing the warehouse more than the efficiencies actually achieved by the employees in performing the processes and, second, by granting bonuses at lower levels, employees tend to perform just enough to get what they feel is a desirable bonus for an effort that is less than an optimally motivated employee might put out. By moving the threshold for bonuses upward closer to their optimal level, employees will generally set their own balance between effort spent and reward to favor higher achievement.

Just as in many areas of economic endeavor, the concept of elasticity that employee performance will change in response to changes in the rate of bonuses, ends up describing a rough inverted parabolic curve such that approaching the optimum relationship between performance achieved and bonuses given for that performance from either side presents a smooth curve up to an optimum. The relation between the price of accomplishing a task and the price of the incentive present natural bounds to the use of bonuses alone to incentivize. Where the magnitude of the incentive dominates the value of efficiencies realized by incentivizing the work, the incentive becomes counterproductive. One would naturally question the wisdom of giving out a bonus in excess of any savings realized due to performance gains.

So incentivizing gains in performance is meaningful only within knowable limits. Given the approach of the instant invention, all rewardable parameters such as in the continuing example of picking, the numbers of units moved, the path for movement of the goods, the distance traveled, need not be separately tracked. By using the labor standard, all of these variables are simply wrapped up in the comparison. Judicious selection of a labor standard allows optimization without separately varying each of these distinct variables. There is no benefit to knowing optimum numbers for each separately when the same results or better ones can be achieved with the single metric, the labor standard.

In one exemplary embodiment, during a study phase, an initial labor standard can be designated with little more than an educated guess. In the an iterative system, so long as the there exists an adequate incentive to change behavior, any approximately correct labor standard can be used as a starting point, which, in this exemplary embodiment, is informed and updated in each iteration with the latest performance measurements across the population of employees. In the context of studying the labor standard, and the incentives as they relate to the cost of performing a task, the iterations of the labor standard ought to rapidly converge on an optimum one for coaxing the greatest performance form a group of employees without the price of the incentives extending beyond any savings due to increased performance in light of the incentives. Iterative studies can be used to determine performance that will become the benchmark labor standard.

Specifically, in the iterative study, several instances of performance of a task are used to establish a baseline. Once a first baseline is established, the task is performed again for comparison, in this instance, varying the incentives. The resulting performance is compared to the immediately preceding performance and the difference between the two resulting performances is then calculated, and used to move the threshold in the next iteration. Since the model improves iteration by iteration and adapts to system variation, the resulting performance does as well. Ultimately, an expected performance for each task is selected based upon the iterative process. As this happens during normal operation, convergence should be sufficiently fast to avoid long periods with poor performance.

In the presently preferred embodiment, however, these optimum or nearly optimal labor standards are known, fixed or static and are published to the employees. Setting them as static will assure a predictability in the eyes of the employees that is good for morale. Employees will never be given the sense that the goal post is moving away from their efforts.

While, as described above, fixed incentives are generally good for morale, it is known that varying incentives according to season may be useful to obtain further efficiencies. By way of nonlimiting example, proximity to the Christmas holidays may, in study, be found to cause employees to strive harder for financial bonuses in order to meet their own heightened desire for “found money” to purchase gifts for friends and family. In such a manner, once the efficacy of higher bonuses has been tested in proximity to the holidays, an employer can annually add a holiday premium and can suitably promote the bonus to further motivate the employees. Where no efficacy is shown, the program can be quickly abandoned to optimize performance against bonuses paid.

Having retrieved the labor standard data structure at the block 79, the system and method 10 compares each instance of employee performance of the task for which the labor standard is defined to develop a performance score as described above and adds up all the results to get an overall performance score for that process (e.g. If the standard is 1 minute per location and 1 second per each and the employee in question did 10 locations and 60 eaches then the applicable labor standard would be 1*10+1/60*60=11 minutes. If the employee spent 10 minutes on the process, then the employee's performance score (ELS %) would be 11/10=110% on that process.) Naturally, faster performance rates a higher score by driving up the denominator whereas conversely slower performance drives the score lower.

Because of the variability of vehicle resources, the labor standard may include corrections or normalizations relating to what assets were used. By studying this variability, the additional benefit of the instant method and system 10 is that the financial impact of the composition of the fleet of vehicles can be directly calculated. Relative to the employees, however, if it is known that performance of putaway with reach trucks rather than forklifts requires 20% more time, then, the labor standard in the above example would encompass the use of a reach truck and in the example above, the standard time for performance of the same task becomes 11*120%=13.2 minutes. Having performed the task with a reach truck in 10 minutes, the employee in question earns a normalized score by the same calculation as normalized—13.2 minutes (normalized labor standard)/10 minutes (actual)=132% Thus, at a block 83, the employee scores are normalized for the particular vehicle asset used to perform the task.

Once the system and method 10 properly adjusts for utilization rates, the each employee in each process receives the utilization score. For instance, if the utilization goal for putaway is 50% and the actual utilization for the employee doing putaway is 60%, then his adjusted utilization score is 120% (60%/50%). In a similar manner, for each employee in each process, the scores are suitably prorated to derive, for each employee, an overall daily score (Picking 5 hours at 110% and Putaway 3 hours at 80%=99% for the day).

At a block 89, the system and method 10 then moves to tabulate the total time tracked for the day and the total time is then compared against the time clock hours. To the extent that the employee was paid for more hours than were tracked in the system then a “missing time adjustment” is made to his daily performance score. (For example, if Bob worked 9 hours but was paid for 10 hours, the missing hours adjustment in the report would show 90%. If his original productivity had been 80%, what would show on the report as his “Daily Productivity” would only be 72% (the earned percentage adjusted to reflect the ratio between hours worked and hours paid, the difference being due to the missing hours, thus: 72%=80%* 90%).

Once the system and method 10 arrive at a suitable daily utilization score for each employee, the scores are used in order to motivate employees to either continue optimal performance if they have achieved it based upon their performance score or to urge them toward such performance if they have not. At a block 91, based upon the objectively derived utilization scores the system and method provides 10, the according to such policies as the warehouse manager previously designates, positive recognition, disciplinary action or performance bonuses can then be meted out to the employee. Central to the use of the system and method is transparency and objectivity such that a particular performance score will receive exactly the same result for each employee based on rule sets the company establishes to exploit the performance scores the system and method 10 derive for each of the previous day, week, or month. By providing these performance scores, the system and method provide objective data that has only been available to managers previously through, where available, motion studies in a well-mapped three-dimensioned space. And prior to this solution, achieving such studies has required an astronomical outlay of capital.

Referring to FIG. 4, the data that the system and method 10 derive is further modified to provide employee incentives, and where necessary, discipline. By way of explanation, a nonlimiting exemplary report 100 to a supervisor is depicted. In this non-limiting exemplary report, data are ordered and presented in a report having columns headed with “Rank” 101, “Employee Name” 103, “Daily Productivity” 105 expressed as a percentage, “Missing Hours Adjustment” 107 (that productivity expressed as the adjustment necessary to reflect the missing hours as stated above), “Lifetime Productivity” 109, “Personal Goal” 111 as management designates it per employee, along with the daily “Bonus Earned” 113 and the “Cumulative Bonus” 115 for the pay period.

“Rank” 101 is based upon the sorting criteria designated by the supervisor and simply expresses scoring relative to other employees based upon use of that designated sorting criteria. The “Employee Name” 103 is likewise a conventional feature and is nothing more than the listing of the employee name in order to express the remaining data in a manner useful to the supervisor.

“Daily Productivity” 105 is a productivity score derived by the system and method 10 (FIGS. 1 and 2). In use, this is a raw score. That score is adjusted to account for missing hours and a missing hours adjustment factor is displayed here in association with the employee name under the column headed as “Missing Hours Adjustment” 107. The missing time adjustment score is just the amount of the adjustment factor. Thus, by way of explanation, if an employee should score 200% productivity for the day, and was paid for 10 hours but tracked for only 9 hours, then a missing hours adjustment would be 90% of the total, such that the employee would have a Daily Productivity score corrected for missing hours at 180% (200%*90%)

Having achieved these key criteria from the system and method 10 (FIGS. 1 and 2), the remaining columns are simply derived from these two criteria over time. “Lifetime Productivity” 109 is a cumulative productivity for the duration of an employee's employment. On the first day of employment, the exemplary employee in the preceding paragraph would have a lifetime productivity of 180%. On the second day of employment, the next resulting productivity is averaged. So, by way of further example, if the employee scores a productivity score of 160% on the second day, the Lifetime Productivity Score is now at 170%, the average of 180% from the first day and 160% from the second day. The inclusion of a “Lifetime Productivity” column is to lend insight to the supervisor: by allowing the figure appearing for the employee under the “the Lifetime score as it is altered each day based on each additional daily score, a supervisor can perceive trends in performance. When a daily productivity score contrasts sharply with the figure in the “Lifetime Productivity” 109 column, a supervisor might understand that there may be a significant stressor in the employee's outside life and may, itself, be used as an opportunity to discuss it and to give the employee guidance where necessary. In a similar manner, where an employee is achieves a productivity that exceeds the “Lifetime Productivity” 109, the supervisor might understand that an employee has either mastered a task or is putting forth a superior effort and ought to be recognized for doing so.

In a distinct example, after discipline, an employee might redouble their efforts. As is known too often in the world of management to require citation, an borderline employee might begin to reform and improve but might, if the supervisor fails to recognize that improvement over a short time, tend to slip back into the habits that caused the supervisor to single that employee out for discipline in the first place. By providing the supervisor with immediate feedback, the supervisor is also armed with statistics that can be used by the supervisor as a basis for meeting with the employee and praising them for their improved performance and thereby to further reinforce the desirability of the improved efforts in the mind of the employee. In this manner, the system and method 10 provide immediate and objective feedback to both the supervisor and the employee.

“Personal Goal” 111 listed for each employee is presumptively always to be at least 100% efficient. Nonetheless, the column is provided to a supervisor for specific amendment of employee behavior. In one instance, where an employee is, in some manner, prevented from achieving full productivity, for example, an employee who is new to the job, may be allowed to perform at 85% by agreement with the employee to achieve mastery of the tasks Personal goals are strictly for accountability but do not drop the standards for granting of bonuses. Rather, they allow an employee to perform to the extent practical allowing the practice necessary to master the new task without being singled out for deficient performance. To use an old analogy, the employee can avoid the stick in light of the employee's inexperience, but achieving a personal goal doesn't draw the carrot any closer. The personal goal provides the manager with the ability recognize that not all tasks are immediately mastered without undercutting the standard for receiving incentive compensation.

The final two columns further reflect the system and method 10 (FIGS. 1 and 2) exploited in the transition from reckoning objective measures of productivity to granting bonuses in light of those measured productivity criteria. As earlier stated, the bonus structure is designatable by management. Certainly, with the exceptions set forth above, optimal motivation is achieved by a system of a well-selected set of rewards based upon an objective set of productivity goals accompanied by a predictable and transparent scoring of productivity per employee to allow the achievement of those goals. As has been argued above, the scoring system is suitably normalized according to process and available equipment to allow employees to compete on “an even playing field” lending the well-selected and objective qualities sought to the system and method 10 (FIGS. 1 and 2). Thus it remains to management to assure a well-selected set of rewards based upon an objective set of standards

It is the intent of the inventors to exploit the above-described iterative system to continue to refine the relationship between defined goals and offered bonuses and, where necessary, discipline for the achieving or failing to achieve the defined goals. In any regard, the structure is designatable and readily incorporated into the system. Precise numbers selected are not relevant to the patentability of the system, rather that the numbers may be so incorporated lends further novelty to the system and method 10 (FIGS. 1 and 2).

At the heart of any system for providing employees with incentives lies a metric comparing the price of incentives to the gains achieved by providing the incentives. A further feature of the system and method 10 (FIGS. 1 and 2), the report depicted in FIG. 5 demonstrates costs of incentives along with standard payment for a full-in cost and predicting economies of each bonus incentive and the aggregate cost per unit of providing the incentives. Shown here in graphic form is an estimated or “Budgeted Cost per Unit” 201 as it varies by month and the “Actual Cost per Unit” 203. For each employee, the instant exemplary report also shows the number of “Units per Hour” 205 an employee moved, the “Cost per Unit” 207, the total “Hours” 209 worked, how the employee scored against the standard productivity management designates or “Labor Standard” 211, and finally, the “Total Cost” 213, or what actual dollars the employee's efforts on this project cost to the warehouse.

For the system and method 10, the actual derivation of these numbers is based upon known variables such as the employee's burdened hourly rate and derived variables such as the specific bonus costs management, through use of the system and method 10, has elected to pay the employee. For each employee, the number of employee hours worked is multiplied by the employee's designated pay rate and across the employee's work per pay period, the burdened cost, in to come up with the cost of the work they performed in accord with Generally Accepted Accounting Principles (GAAP). Where appropriate, overtime and such adjustments as the performance of work during overtime intervals necessitates is added to the hourly costs. In each instance as the employee accrues bonuses as explained above, those bonuses are rolled into the average hourly costs as necessary to comply with GAAP. In this manner, a figure that exactly states the daily cost of an employee's hours. When, then the number of units the employee moves in each hour, the cost per unit is the quotient between the cost per hour and the units per hour. That cost is then applied to the applicable processes and compared against the units produced to determine unit cost and overall cost for each process and sub-category. In this manner, as shown in FIG. 5, in each process, the efforts of the employees can then be compared to their labor budget or used to analyze the cost of a specific process in the manner provide in the report 200, or against other known criteria such as per customer or per category, etc.

While the preferred embodiment of the invention has been illustrated and described, as noted above, many changes can be made without departing from the spirit and scope of the invention. For example, distinct reports are possible lending to the supervisors much more refined views of their own employee's costs and incentives. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computer-assisted method for distributing incentive payments to employees performing warehouse tasks, the payments to reward productivity, the method comprising, each under the control of a computer system:
receiving, from sensors on a vehicle having a vehicle code, data including time-stamped event data memorializing:
trip onset and trip conclusion events associated a vehicle code; and
lift events, laden time, and trip distance associated with the vehicle code;
deriving a utilization percentage based upon the received trip onset, and trip conclusion events, lift events, and laden time associated with the trip;
receiving job code, and job onset and job conclusion events together defining the segment;
deriving a performance score relative to a labor standard for that job code for each segment based upon job code, job onset, job conclusion and the utilization percentage;
retrieving an employee code associated with each job code and time clock events including clock in and clock out data associated with the employee code; and
aggregating performance scores of each employee, in each segment, according to clock in and clock out data.

2. The method of claim 1 further comprising drafting a check for each employee to include a bonus based upon the aggregated performance score.

3. The method of claim 2 wherein the drafting a check includes aggregating all performance scores within an employee pay period.

4. The method of claim 1 wherein aggregating performance scores for each employee includes publishing the performance score to at least one employee.

5. The method of claim 1, wherein deriving a performance score includes:
calculating a tracked time ratio for all segments within each interval bounded by clock in and clock out events associated with the employee code within the interval.

6. The method of claim 1, wherein:
receiving lift events includes doubling lift time in order to include time for lowering the lift and therewith to develop a lift percentage within each segment.

7. The method of claim 6, wherein deriving a utilization percentage includes:
aggregating lift percentage and movement percentage.

8. The method of claim 1 wherein deriving a performance score includes:
aggregating laden time and movement within a segment to produce a utilization time for the segment; and
aggregating the utilization time bounded by for all segments bounded by clock in and clock out events associated with the employee code within the interval for each segment.

9. The method of claim 1, wherein receiving job code, and job onset and job conclusion events includes:
receiving information from a warehouse management system (WMS) indicating movement of identified goods from a first location to a second location; and
temporally locating the movement within a segment.

10. The method of claim 9, further including:
defining such new segments as necessary to bracket movement of identified goods not conforming with received job codes, job onset and job conclusion data.

11. A system to derive incentive payments to employees of a warehouse based upon performance of warehouse tasks, the system comprising:
one or more processing units including, among them, at least one tangible computer readable medium including computer readable program code logic to command the one or more processing units according to said computer readable program code logic, when executing, to perform the following:
receiving, from sensors on a vehicle having a vehicle code, data including time-stamped event data memorializing:
trip onset and trip conclusion events associated a vehicle code; and
lift events, and laden time associated with the vehicle code;
deriving a utilization percentage based upon the received trip onset, and trip conclusion events, lift events, and laden time;
receiving job code, and job onset and job conclusion events together defining the segment;
deriving a performance score relative to a labor standard for that job code for each segment based upon job code, job onset, job conclusion and the utilization percentage;
retrieving an employee code associated with each job code and time clock events including clock in and clock out data associated with the employee code; and
aggregating performance scores of each employee, in each segment, according to clock in and clock out data.

12. The system of claim 11, further configured to perform:
drafting a check for each employee to include a bonus based upon the aggregated performance score.

13. The system of claim 12, wherein the drafting a check includes aggregating all performance scores within an employee pay period.

14. The system of claim 11, wherein aggregating performance scores for each employee includes publishing the performance score to a at least one employee.

15. The system of claim 11, wherein deriving a performance score includes:
calculating a tracked time ratio for all segments within each interval bounded by clock in and clock out events associated with the employee code within the interval.

16. The system of claim 11, wherein:
receiving lift events includes doubling lift time in order to include time for lowering the lift and therewith to develop a lift percentage within each segment.

17. The system of claim 16, wherein deriving a utilization percentage includes:
aggregating lift percentage and movement percentage.

18. The system of claim 11, wherein deriving a performance score includes:
aggregating laden time and movement within a segment to produce a utilization time for the segment; and
aggregating the utilization time bounded by for all segments bounded by clock in and clock out events associated with the employee code within the interval for each segment.

19. The system of claim 11, wherein receiving job code, and job onset and job conclusion events includes:
receiving information from a warehouse management system (WMS) indicating movement of identified goods from a first location to a second location; and
temporally locating the movement within a segment.

20. The system of claim 19, further including:
defining such new segments as necessary to bracket movement of identified goods not conforming with received job codes, job onset and job conclusion data.
